(19) United States
(12) Patent Application Publication
(10) Pub. No.: US 2014/0279509 A1
(43) Pub. Date: Sep. 18, 2014

(54) METHOD FOR IMPLEMENTING AN ALTERNATIVE PAYMENT

(71) Applicant: FACEBOOK, INC., Menlo Park, CA (US)

(72) Inventors: Reshma Khilnani, Menlo Park, CA (US); Yongyan Liu, Menlo Park, CA (US); Abhishek Doshi, Menlo Park, CA (US)

(73) Assignee: FACEBOOK, INC., Menlo Park, CA (US)

(21) Appl. No.: 13/828,150

(22) Filed: Mar. 14, 2013

(51) Int. Cl. G06Q 20/22

(52) U.S. Cl. CPC G06Q 20/227
USPC 705/44

(57) ABSTRACT

One variation of a method includes: receiving a transaction request, the transaction request comprising an identity of a user, a location of a vendor, and a price of a transaction; identifying a set of payment methods available to the user, a particular payment method in the set of payment methods characterized by a discrete payment structure defining a discrete payment increment; ranking the available payment methods according to a preferred payment method associated with the location of the vendor, according to the discrete payment structure of the particular payment method, and according to the price of the transaction; receiving a selection from the user for the particular payment method for the transaction; and authorizing a payment to the vendor with the particular payment method.

### CROSS-REFERENCE TO RELATED APPLICATIONS

This application is related to: U.S. Patent Application No. 61/849,813, filed on 31 Jan. 2013 and titled “METHODS FOR ENABLING GIFT CARD TRANSACTIONS”; U.S. patent application Ser. No. 13/239,340, filed on 21 Sep. 2011 and titled “Structured Objects and Actions on a Social Networking System”; U.S. patent application Ser. No. 12/508,521, filed on 23 Jul. 2009 and titled “Markup Language for Incorporating Social Networking Information by an External Website”; U.S. Pat. No. 8,250,145, issued on 21 Aug. 2012 and titled “Personalizing a Web Page Outside of a Social Networking System with Content from the Social Networking System”; and U.S. patent application Ser. No. 12/969,368, filed on 15 Dec. 2010 and titled “Comment Plug-In for Third Party System,” all of which are incorporated in their entirety by this reference.

### TECHNICAL FIELD

This invention relates generally to the field of electronic payments, and more specifically to a new and useful method for implementing an alternative payment.

### BACKGROUND

Online or application-based storefronts require consumers to supply a form of electronic payment to complete a transaction. Consumers often supply standard credit card or debit card information to complete payment, but other alternative payment methods also exist as eligible payment methods for such transactions.

However, implementation of the plethora of alternative payment methods—and access to rules governing their use—is often difficult and confusing for consumers and can be burdensome for vendors.

### BRIEF DESCRIPTION OF THE FIGURES

FIG. 1 is a flowchart representation of a method of an embodiment;

FIG. 2 is a flowchart representation of a variation of the method;

FIG. 3 is a flowchart representation of a variation of the method; and

FIG. 4 is a flowchart representation of a variation of the method.

### DESCRIPTION OF THE EMBODIMENTS

The following description of the embodiments of the invention is not intended to limit the invention to these embodiments, but rather to enable any person skilled in the art to make and use this invention.

As shown in FIG. 1, method S100 for implementing an alternative payment includes receiving a transaction request including an identity of a user, a location of a vendor, and a price of a transaction in Block S110; identifying a set of payment methods available to the user, a particular payment method in the set of payment methods characterized by a discrete payment structure defining a discrete payment increment in Block S120; ranking the available payment methods according to a preferred payment method associated with the location of the vendor, according to the discrete payment structure of the particular payment method, and according to the price of the transaction in Block S130; receiving a selection from the user for the particular payment method for the transaction in Block S140; and authorizing a payment to the vendor with the particular payment method in Block S150.

As shown in FIG. 2, one variation of method S100 for implementing an alternative payment includes: associating a set of payment methods with an account of a user, each payment method in the set of payment methods characterized by a discrete payment structure defining a discrete payment increment in Block S102; receiving a transaction request including an identity of a user, a location, and a price of a transaction in Block S110; ranking the set of payment methods according to a preferred payment method associated with the location and according to a payment increment, in the payment increments of the set of payment methods, that is within a threshold range of the price of the transaction in Block S130; receiving, from the user through a mobile computing device, a selection for a particular payment method, in the set of payment methods, for the transaction in Block S140; and authorizing a payment to the vendor with the particular payment method in Block S150.

As shown in FIG. 4, method S100 functions to enable transactions with local currency through various alternative payment methods available to a user through a mobile, online, and/or other electronic account. Generally, in response to a transaction request, method S100 accesses various payment methods, ranks the payment methods for the transaction according to various constraints, matches a payment schedule of a selected payment method to a price of the transaction, and authenticates payment for the transaction. Method S100 can implement various common and/or exotic payment methods to pay for the transaction, such as credit cards, debits cards, mobile payments through cellular (i.e., mobile) carriers, near-field communication (NFC) payments, electronic wallets, e-commerce payment services, gift cards, offers, vouchers, etc., regardless of characteristics or limitations of each payment method. Method S100 can rank available payments for a particular transaction and/or automatically match a payment to the particular transaction based on location, a local currency, the price of the transaction, an item of the transaction, user data or user risk, payment carrier risk or current contract details, and/or based on any other factor or constraint in order to enable a transaction between a user and a vendor with a suitable and/or preferred payment method.

As shown in FIG. 4, method S100 can be particularly applicable to transactions for digital goods, wherein method S100 accounts for a location, a contract, and/or another constraint of a user, a (digital good) developer, a payment carrier, and a payment platform. For example, a social networking system can host the payment platform and maintain contracts for various payment methods from various payment carriers, and the user can access an electronic storefront through a mobile computing device (e.g., smartphone, tablet, personal music player, personal data assistant (PDA)) and select an electronic good (e.g., a native application, a music file) for purchase. The social networking system can further implement method S100 to rank available payment methods from the payment carriers and, in response to a payment method selection through the mobile computing device, authenticate distribution of the payment from the user, through the payment carrier, and to the developer and the social networking system according to a relevant contract. The social networking system can also manage conversion of components of the payment to suitable or preferred currencies for each party. For example, the user can be located in Brazil, transact through a social networking system incorporated in the United States of America, purchase a social networking application produced by a developer in Russia, and submit payment for purchase in a local currency (e.g., Brazilian reals). Method S100 can thus convert portions of the payment from reals into American dollars and Russian rubles according to current exchange rates and contractual payment distribution within the transaction.

Additionally or alternatively, method S100 can be applicable to transactions for tangible goods (e.g., products, services), wherein method S100 accounts for a physical location, contract, and/or another constraint of a user, a vendor, a payment carrier, and a payment platform. For example, the user can enter a physical storefront, select an item to purchase, and initiate a transaction with the storefront through a mobile computing device. Similar to the implementation described above, the social networking system can receive a transaction request, implement method S100 to rank available payment methods from the payment carriers, send a ranked list of payment methods to the user's mobile computing device, and, in response to a payment method selection on the mobile computing device, authenticate distribution of the payment from the user, through the payment carrier, and to the storefront and the social networking system according to current exchange rates and contractual payment distribution within the transaction. For example, the user can be a tourist in Brazil, enter a local vendor to purchase a tangible product, access a payment profile (within a social networking system incorporated in the United States of America) through a smartphone supported by a mobile carrier in the user's home country of Italy, and submit initial payment for the purchase in Euros. Method S100 can thus convert portions of the payment from Euros into American dollars and Brazilian reals to pay the social networking system and vendor, respectively, and apportion some of the payment in Euros for the mobile carrier. However, method S100 can be implemented in any other way by any other entity and for any other type of transaction.

Method S100 can be implemented by a computer system, such as a payment platform within a social networking system that receives transaction request from vendors and/or users, ranks available payment methods according to user and transaction data, and verifies payments for transactions according to user payment method selections. The computer system can be a cloud-based computer (e.g., Amazon EC3), a mainframe computer system, a grid-computer system, or any other suitable computer system. The computer system can support a payment aggregator, within the payment platform, to host multiple local payment systems supported by various mobile carriers, payment services, local or regional banks, creditors, etc., wherein the payment aggregator enables access to various payment systems through a single channel. The payment platform can also support or maintain carrier-specific pricing and contracts (e.g., a revenue-share contract), match payment systems (i.e., payment methods) with a user and a current transaction, and/or handle currency exchange between multiple parties, such as a vendor, merchant, storefront (e.g., physical location, an “app” store), a user, a payment carrier, and a payment platform or point of sale system. For example, the computer system can interface with currency markets, payment and transaction channels, etc., over a distributed network, such as over the Internet, to handle transactions between users and vendors in real time. In this example, one or more processors throughout the distributed network can implement one or more Blocks of method S100. The computer system can also incorporate a vendor-side interface and/or a user-side interface. The vendor-side interface can enable a vendor (e.g., a brick-and-mortar storefront, a native “app” developer, a electronic or online storefront, etc.) to define a location, set a preferred currency option, describe digital or tangible sale items, review or define a contract or revenue share model, initiate a transaction with a user, etc. The user-side interface can display ranked payment methods to the user and enable the user to select a payment method, initiate a transaction, submit preferences or user data, create or edit a payment and/or social networking profile, etc. Generally, the vendor- and/or user-side interfaces can each be accessible through a web browser or through a native application executing on a computing device, such as a laptop computer, a desktop computer, a tablet, a smartphone, a PDA, a personal music player, etc. Furthermore, the vendor- and/or user-side interfaces can also be internal or external a social networking system that implements the payment platform. The social networking system can also contain and/or access relevant user, vendor, product, currency, payment history, revenue-share contracts, or other relevant information. However, method S100 can be implemented by any other entity, party, payment platform, payment aggregator, etc. to enable payment between users and vendors with alternative payments.

As shown in FIG. 2, one variation of method S100 includes Block S102, which recites associating a set (i.e., one or more) of payment methods with an account of a user, each payment method in the set of payment methods characterized by a discrete payment structure defining a discrete payment increment. Generally, Block S102 functions to identify payment methods available to the user when transacting with one or more vendors, including an alternative payment method with discrete payment structure defining a discrete payment increment. Commonly, alternative payment methods define discrete “price points,” or discrete payment increment, rather that continuous price points. For example, an alternative payment method can define discreet price points of $1, $2, $5, $10, $25, and $50 with a $50 maximum, whereas a standard payment method defines continuous price points that permit payments from $0.1 (or fractions of a cent) up to a credit limit, up to a maximum available fund, etc. In another example, an alternative payment method can be associated with a stored value account, wherein the only price point of the alternative payment method is the full value in the stored value account. Alternatively, one alternative payment method can define different price points for different users, locations, or vendors, such as based on user payment history, local laws, or a vendor contract. Similarly, two alternative payment methods can define different price points for the same user, location, or vendor. Block S102 can thus handle multiple alternative payment methods and/or one or more standard payment methods.

Block S102 can associate one or more alternative (and/or standard) payment methods with a payment account of a user. The payment account can include payment methods verified by the user, such as by connecting an email address, phone number, social security number, a PIN number, and/or user signature to each payment method. The payment account can also be connected to, linked to, or a subs-account of a social networking profile of the user within the social networking system. Block S102 can associate a substantially unique set of payment methods with the user's payment account, such as based on payment methods subscribed to by the user or available to the user based on the user's location or payment history. The payment account can be accessible to the user through the social networking system (e.g., through the user's social networking profile), such as through a native social networking application executing on a smartphone, or independently of the social networking system, such as through a native payment application executing on a smartphone. The payment profile (and social networking profile) can be linked to a cellular number, email address, username, credit card number, gift card number, or other identifier that can be received in Block S110 to identify the user. However, Block S102 can function in any other way to associate a set of payment methods with a payment account of the user.

Block S110 of method S100 recites receiving a transaction request including an identity of a user, a location of a vendor, and a price of a transaction in Block S110. Generally, Block S110 functions to receive details of a transaction necessary to identify the user, determine transaction parameters, and rank the payment methods for the user and for the transaction. As shown in FIG. 3, various transactions details can be received directly by the vendor, such as the price of the transaction, which is set by the vendor. Alternatively, transaction details can be received directly from the user (E.g., through a mobile computing device) or indirectly from the user through the vendor, such as the user's account username or other identifier. Block S110 can also determine various transactions details based on other transaction details received from the user and/or vendor. For example, Block S110 can receive a vendor identifier, access a database of vendors and associated locations, and determine a location of the transaction (i.e., a location of one entity of the transaction) based on a location of the vendor stored in the database. In another example, Block S110 can receive a Global Positioning System (GPS) coordinate of a smartphone associated with the user (an implemented in the transaction) at the time of the transaction and cross-reference the GPS coordinates with a database of GPS coordinates to determine the location of the user.

In one implementation, Block S110 receives the transaction request that includes a cellular phone number that is the identifier of the user. The phone number can be associated with the user's payment account (and/or social networking profile) and thus act as a primary point of entry for alternatively payment methods hosted by the payment platform (e.g., with the social networking system). Alternatively, Block S110 can receive an email address, username, PIN number, user payment credential, or other data to identify the user.

Block S110 can additionally or alternatively receive, from the vendor and/or the user, any one or more of a country or region of one party of the transaction, a preferred payment method associated with the location, an instrument of the transaction (e.g., a credit card reader, the user's smartphone), a country code, a currency code of a local currency, a time of the transaction (e.g., to implement the exchange rate at the time of the transaction in the final payment), and a type or description of the good. For example, Block S110 can receive an identifier of a class of good, in the transaction, that specifies one of a virtual good, a tangible good, and an advertisement selection. Alternatively, as described above, Block 110 can extrapolate any of the foregoing data. For example, Block S110 can receive a vendor ID, access a vendor database to identify the vendor and determine the vendor's location, and then determine a preferred currency and associated currency code based on the determined vendor location.

Transaction details can be transmitted from the vendor interface through a remote server and/or over a distributed network and received in Block S110. Additionally or alternatively, Block S110 can receive transaction details directly from the user, such a through a payment aggregator applet executing within a native vendor application or executing within a web browser accessing a vendor website, such as shown in FIG. 4. For example, the vendor and/or user can push the transaction request to the payment platform implementing Block S110 substantially in real time when the user initiates a purchase from the vendor. However, Block S110 can receive the transaction request in any other way.

Block S120 of method S100 recites identifying a set of payment methods available to the user, a particular payment method in the set of payment methods characterized by a discrete payment structure defining a discrete payment increment. Generally, Block S120 functions to select a subset of all payment methods supported by the payment platform, wherein the subset of payment methods is suitable for the transaction. In one implementation, Block S120 selects payment methods, from payment methods contracted with the payment platform, that have been verified by the user and accepted by the vendor. For example, Block S110 can determining a preferred currency of the vendor, such as based on the location of the vendor as described above, and Block S120 can select the set of payment methods, for the transaction, that implement the preferred currency of the vendor. Block S120 can additionally or alternatively can select the set of payment methods that are hosted by carriers local to the vendor, such as within the same state, country, or region as the vendor (and/or user).

Block S120 can handle alternative payment methods by filtering alternative payment methods supported by the payment platform to identify particular alternative payment methods applicable to the transaction. For example, Block S120 can implement any foregoing and/or forthcoming constraints to select a subset of alternative payment methods characterized by discrete payment structures defining discrete price points or payment increments. Block S120 can also select alternative payment methods that include price points within a threshold range of the price of the transaction and exclude payment methods with price points outside of the threshold range of the transaction price. For a received price of the transaction that is $1.27, Block S120 can select a first alternative payment method that includes price points of $1, $1.50, S2, $2.50, $5, etc., and Block S120 can exclude a second alternative payment method that only includes price points greater than $2. In this example, Block S120 can thus define the threshold range as $0.25 (or $0.50) for transaction prices under $2, which thus excludes the second payment method from the current transaction. However, Block S120 can also define additional threshold ranges, such as based on transaction price. For example, Block S120 can also define a $0.50 threshold range for transaction prices between $2 and $5, a $1 threshold range for transaction prices between $5 and $10, and a $2.50 threshold range for transaction prices between $10 and $20.

Block S120 can additionally or alternatively handle standard payment methods, characterized by continuous payment structures, to identify particular standard payment methods applicable to the transaction. However, Block S120 can identify alternative and/or standard payment methods available to the user for the transaction in any other suitable way.

Block S130 of method S100 recites ranking the available payment methods according to a preferred payment method associated with the location of the vendor, according to the discrete payment structure of the particular payment method, and according to the price of the transaction. Generally, Block S130 of method S100 functions to enable flexible payment method matching by ordering payment methods applicable to the transaction according to various factors, thereby guiding the user to select a suitable or preferred payment method in Block S140.

Block S130 can rank the available payment methods according to constraints that are common across users or vendors. For example, Block S130 can rank an available payment method according to user or vendor location, location or state of incorporation of the payment method or payment platform, a preferred local payment method, a local currency or involved currencies, current exchange rates, a transaction instrument (e.g., the user's smartphone, a payment processing service), the price of the transaction, local or involved languages, class of good, payment method price points, common payment method selections within the user's demographic (e.g., age, gender, ethnicity, cultural background, debt level, income level, education level), etc. Additionally or alternatively, Block S130 can rank available payment methods according to constraints unique to the vendor or user. For example, Block S130 can rank an available payment method according to the vendor's preferred payment method, a previous payment selection of the user, a user's payment history (e.g., which payment method debts the user pays off and in what period of time), personal user credit limits or payment plans, user credentials, etc. However, Block S130 can rank the payment methods according to any other constraint(s).

In one example implementation, Block S130 ranks payment methods according to local, vendor, and/or user preferences. In one example, Block S130 ranks a first payment method that is preferred by the vendor over a second payment method that is preferred by the user (e.g., based on previous user payment method selections), and Block S130 ranks the second payment method over a third payment method preferred by local users (e.g., based on common payment selections by other users in the same region or location as the user). In this implementation, Block S130 can access a user payment profile (e.g., connected to the user's social networking profile with the social networking system that host the payment platform), wherein the user's payment profile includes payment method selections made by the user for prior transactions. Block S130 can thus extrapolate user payment preferences from the user's payment history.

In another example implementation, Block S130 ranks the set of payment methods according to a preferred payment method associated with the location and according to payment increments (i.e., price points), of the available payment methods, that are within threshold ranges of the price of the transaction. For example, the payment platform can extrapolate preferred payment methods for various user or vendor locations based on payment methods commonly selected for the locations, and the payment platform can stored the determined preferred payment methods in a local preferred payments database. Block S130 thus can receive a GPS location from the users smartphone or determine the location of the vendor based on a database of vendor locations, access the local preferred payments database, and rank the payment methods for the present transaction based on correlations between the available payment methods and preferred payment methods associated with the received or determined location the user or vendor.

In another example implementation, Block S130 ranks the available payment methods according to a difference between price points of the available payment methods and the price of the transaction. For example, for a price of the transaction that is $1.27, Block S130 can rank a first alternative payment method that includes price points of $1 and $1.50 ahead of a second price point that include price points of $2 and $5. In this example, Block S130 can thus rank payment methods with price points nearer the price of the transaction higher than payment methods with price points further from the price of the transaction. However, in this example, Block S130 can also rank a third alternative payment method that includes price points of $1 and $2 ahead of the first payment method in light of local or vendor preference for the third payment method over the first payment method. Thus, Block S130 can also account for local, vendor, and/or user preferences in addition to price points when ranking the available payment methods.

In the foregoing example implementation, Block S130 can further rank available payment methods based on availability or a cost of subsidizing a deficient payment or absorbing an excess payment. For example, Block S130 can access rules for transactions with payment carriers hosting certain payment methods, such as rules specified in current contracts with the payment platform, and Block S130 can rank payment methods according to maximum or minimum subsidy values and/or payment absorption amounts. Block S120 can similarly access current contracts to select (or eliminate) payment methods that do (or do not) allow for payment subsidies and/or excess payment absorption in light of the price of the transaction.

In yet another example implementation, Block S130 ranks the set of payment methods according to revenue-share contracts between the payment platform and carriers supporting the payment methods. For example, Block S130 can rank a first alternative payment method before a second alternative payment method, wherein the first payment method is associated with a revenue-share contract dedicating 80% of the payment to the vendor, 6% to the carrier, and 14% to the payment platform, and wherein the second payment method is associated with a revenue-share contract dedicating 82% of the payment to the vendor, 8% to the carrier, and 10% to the payment platform.

In a further example implementation, Block S130 accounts for the price of the transaction in ranking the payment methods. For example, for transaction prices below a threshold price (e.g., $2) Block S130 can rank payment methods with transactions dedicating relatively lower payment percentages to the payment platform than payment methods with transactions dedicating relatively higher payment percentage to the payment platform. Similarly, for transaction prices above or between threshold prices (e.g., $2, $2 to $4.99) Block S130 can rank payment methods with transactions dedicating relatively higher payment percentages to the payment platform than payment methods with transactions dedicating relatively lower payment percentage to the payment platform.

A payment method selected for a previous transaction may have included a nearest (or applied) price point that was less than the price of the previous transaction, which may have yielded an ‘underage’ when the payment method was applied to the previous transaction. In this event, the payment platform may have subsidized the remainder of the price of the previous transaction in order to enable completion of the transaction regardless of the deficient price point of the payment method. The payment platform can further track a total outstanding subsidized amount for completed transactions by the user and/or a total outstanding subsidized amount for completed transactions by multiple users (e.g., all users, users in a particular region), such as within a certain period of time. Block S130 can thus reference the total outstanding subsidized amount when ranking the available payments for the transaction. For example, Block S130 can rank available payment methods based on nearest (or near) price points that are greater than the price of the transaction such that the payment platform can recuperate the total outstanding subsidized amount by absorbing excess payment from the payment method selected in Block S140 and applied to the transaction. The payment platform can similarly absorb an excess payment from a previous transaction paid for with a payment method with a nearest (or applied) price point that was greater than the transaction price, which can yield an ‘overage.’ Block S130 can thus rank available payment methods based on nearest (or near) price points that are less than the price of the transaction such that the payment platform can reduce the absorbed balance from previous excess payments. Block S130 can thus rank payment methods for the user based on outstanding subsidy amounts and/or absorbed payment amounts for the user or for multiple users within the payment platform.

In one variation of method S100, upon first use of a new cellular phone number as payment method in a first transaction, a cellular carrier may be unknown at the time of the first transaction, and Block S130 can thus estimate a generic price point for a payment method supported by the mobile carrier. For example, Block S130 can assign the price point that is a payout amount of a lowest common denominator value common to the location of the user. Block S130 can also implement a cellular phone number lookup service to identify the mobile carrier associated with the cellular phone number and then assign a price point implemented by or common to the mobile carrier. Block S130 can thus implement the estimated or determined price point of the payment method when ranking the available payment methods. Block S130 can also store the cellular phone number, determined mobile carrier, and/or estimated price point for use in a subsequent transaction.

In a further example implementation, Block S130 can rank the available payment methods according to the class of good in the transaction.

As shown in FIG. 2, one variation of method S100 includes Block S132, which recites assessing a transaction risk for the particular payment method. Generally, Block S132 functions to assess a risk of implementing a payment method in the transaction, such as based on the user's transaction history, a contract with the payment carrier, outstanding payment subsidies or absorbed payment amounts, and/or any other relevant factor. In one example implementation, Block S132 assesses transactional risk on a per-carrier basis. For example, Block S132 can assign a higher risk to a payment carrier incorporated in a high-risk location (e.g., a country with civil unrest) or in a country with a relatively unstable currency. In another example, Block S132 can determine payment method risk based on underage risk and a payout from the payment carrier (e.g., based on a contract with the payment carrier). In another example implementation, Block S132 can assess payment method risk based on user profile data and/or user payment history. For example, Block S132 can estimate a higher risk for a payment method from an account that is past due or for a payment method that the user rarely if ever uses. Block S132 can also assign risk to a payment method based on payment method feedback from various users and/or vendors of the payment platform, such as by assigning lower risk to payment methods with better user and/or vendor feedback. However, Block S132 can assess payment method risk in any other suitable way.

Block S130 can additionally or alternatively rank available payment methods based on assessed payment method risk. For example, Block S130 can rank a first payment method with lower assessed risk before a second payment method with higher assessed risk. However, Block S130 can function in any other way to rank the available payment methods according to any one or more constraints. In light of the various factors and constraints implemented by Block S130 to rank the payment methods for the user, the particular ranked list of payment methods for the transaction can be substantially unique to the user, wherein Block S130 outputs a dissimilar ranked list of payment methods for a similar transaction for another user. Furthermore, Block S120 can implement any of the foregoing methods, techniques, and/or constraints to filter payment methods available for the transaction, and Block S120 can also select a substantially unique list of payment methods for users initiating similar transactions.

Alternatively, Block S130 can select a single payment method, from the set of available payment methods, to apply to the transaction. Block S130 can thus match a particular payment method to the transaction, such as based on any one or more of the foregoing received, determined, and/or assessed factors.

Block S140 of method S100 recites receiving a selection from the user for the particular payment method for the transaction. Block S140 can thus enable the user to select a particular (i.e., preferred) payment method from the ranked list of payment methods output in Block S130.

In one implementation, the payment platform transmits the ranked list of payment methods (output in Block S130) to a mobile computing device (e.g., smartphone) of the user, such as to a cellular phone number associated with the mobile computing device or to an email address associated with the user. The mobile computing device can display the ranked list of payment methods from which the user can select a preferred payment method to apply to the transaction. For example, as shown in FIG. 4, the mobile computing device can display the ranked list of payment methods on a touchscreen integrated into the mobile computing device, and the user can touch a respective region of the touchscreen to select the preferred payment method. Block S140 can thus receive the user's selection from the mobile computing device, such as over the Internet through cellular or Wi-Fi communication protocol.

In another implementation, the payment platform transmits the ranked list of payment methods to the vendor such that the user can interface with the vendor to select the payment method to apply to the transaction. In one example of this implementation, the payment platform transmits the ranked list of payment methods (e.g., through a remote server, over the Internet, via network connection) to a storefront of the vendor such that the user can engage a physical interface (e.g., a transaction menu in a checkout apparatus) to select the payment method. In another example of this implementation, the payment platform transmits the ranked list of payment methods to a server that hosts or is in communication with an electronic vendor, wherein the user can select the payment method, from the ranked list of payment methods, through a web portal, through a transaction checkout page in a native application, or through another vendor-related transaction menu. Block S140 can thus receive the user's selection directly from the vendor.

Block S140 can further implement machine learning and/or A-B testing to build a payment selection model for a set of users, such as based on location, age, and mobile carrier. For example, for similar transactions with different users of a similar demographic, Block S120 and Block S130 can select and rank available payment methods differently for each transaction, such as by ranking a first payment method first and a second payment method second for a first user and ranking the second payment method first and the first payment method second for a second user. Block S140 can thus receive payment method selections, from the different ranked lists of payment methods and then build a model of predicted user selections. Block S140 can also implement machine learning to adjust or improve the user selection model over time and in response to additional payment method selections from various users. Block S120 and/or Block S130 can subsequently implement the user selection model to select and rank available payment methods for a subsequent transaction. However, Block S140 can function in any other way to receive the user's payment method selection for the transaction.

Block S150 of method S100 recites authorizing a payment to the vendor with the particular payment method. Generally, Block S150 functions to initiate payment for the transaction with the payment method selected by the user (or matched to the transaction in Block S130). For example, Block S150 can communicate with the payment carrier to submit payment to the vendor, such as through a debit account or credit account held in the name of the user by the payment carrier. Alternatively, Block S150 can initiate transmission of digital currency from the payment carrier to the payment platform and distribute payment to the vendor accordingly. Yet alternatively, Block S150 can transmit verification of a viable payment to the vendor and adjust or augment one or more electronic ledgers between the payment platform, the payment carrier, the user, and/or the vendor, etc. accordingly. Parties of the transaction can subsequently settle components of the transaction accordingly to the one or more electronic ledgers.

Block S150 can further identify a carrier of the selected payment method, access a revenue-share or other contract with the carrier, and authorize the payment from the carrier to the vendor (or adjust an electronic ledger) according to the revenue share contract (as shown in FIG. 3). For transaction parties (i.e., the payment platform, the vendor, the user, the payment carrier) that implement dissimilar currencies, Block S150 can also access an exchange rate between currencies accepted by the vendor and implemented by the carrier, and Block S150 can lock the exchange rate for the transaction. For example, as described above, Block S110 can receive a time of the transaction, and Block S150 can retrieve exchange rates between currencies implemented by parties of the transaction at the time of, around the time of, or with a time bloc (e.g., one hour) of the transaction. Block S150 can set these exchange rates throughout the ‘life’ or duration of the transaction, such as until payment is appropriately distributed, or for a specified period of time, such as for ten minutes following initiating of the transaction. Alternatively, Block S150 can receive current or negotiated exchange rates from various parties of the transaction, such as an agreed-upon exchange rate between the payment carrier and the vendor from a limited period of time (e.g., one hour). Block S150 can therefore handle exchange rates, when applicable, on a per-transaction basis, on a per-transaction-batch basis, or in any other suitable way.

Block S150 can authorize a single monetary payment from the payment method for the transaction, such as if a price point of the payment method falls within a specified threshold of the price of the transaction. Alternatively, Block S150 can authorize multiple payments from the payment method for the transaction, such as according to discrete price points (i.e., payment increments) of the selected payment method, wherein a sum of the multiple payments falls within a threshold range of the price of the transaction. For example, for a transaction with a price of $1.27, Block S150 can authorize a single payment from a payment method with a $1.50 price point, and the payment platform can hold or absorb the $0.23 excess for the transaction. However, for a transaction with a price of $11.17, Block S150 can authorize two payments of $5 and one payment of $1.50 from a payment method with $1, $2, $5, and $20 price points, and the payment platform can subsidize the additional $0.17 necessary to complete the transaction. In this example, if some of the payments from the payment method fail after Block S150 verifies payment for the transaction to the vendor, Block S150 can augment a log of subsidized transactions and absorbed payments with the cost of the failed transaction, and a subsequent implementation of Block S130 in a future transaction can rank available payment methods to accommodate the loss from the failed transaction. However, Block S150 (and/or the payment platform) can handle a failed transaction in any other suitable way.

As shown in FIGS. 2 and 3, one variation of method S100 includes Block S160, which recites holding an overage for the payment according to the discrete payment increment of the particular payment method than exceeds the price of the transaction. Generally, Block S160 functions to hold an excess portion of a payment in the transaction in the event of a price point of the selected payment method that exceeds the price of the transaction. In one implementation, Block S160 handles or initiates transmission of the overage amount from the carrier of the selected payment method to the payment platform. In another implementation, Block S160 updates an electronic ledger containing transactional information between the payment platform and the payment carrier to reflect the withheld overage. The carrier and payment platform can subsequently settle the overage according to the electronic ledger. Furthermore, Block S120 and/or Block S130 (and/or other Blocks of method S100) can access current overage levels between the payment platform and one or more payment carriers to select and/or rank available payment methods in a subsequent transaction. Block S160 can also reference a carrier payment contract to access rules dictating overage handling for the transaction. However, Block S160 can function in any other way to handle transaction overages.

Similarly, as shown in FIGS. 2 and 3, one variation of method S100 includes Block S170, which recites subsidizing a remainder of the payment according to the price of the transaction that exceeds the discrete payment increment of the particular payment method. Generally, Block S170 functions to subsidize a portion of the price of the transaction in response to selection of a payment method with a price point that is less than the price of the transaction. In one implementation, Block S170 handles or initiates transmission of the underage amount from a holding account of bank account of the payment platform to the vendor. In another implementation, Block S170 updates the electronic ledger containing transactional information between the payment platform and the vendor carrier to reflect the subsidized amount for the transaction. The vendor and the payment platform can subsequently settle the overage according to the electronic ledger. Similar to that described above, Block S120 and/or Block S130 can access current subsidized payment amounts between the payment platform and one or more vendors to select and/or rank available payment methods in a subsequent transaction. Block S160 and Block S170 can also cooperate to maintain an aggregated overage and underage ledger that is unique to the user, to the vendor, to the carrier, that is unique to a subset of users, vendors, or carriers, or that that is general to the payment platform. Block S120 and/or Block S130 can also access the aggregated overage and underage ledger to select and/or rank available payment methods. Furthermore, Block S170 can reference a carrier payment and/or vendor payment contract to access rules dictating underage handling for the transaction. However, Block S170 can function in any other way to handle transaction underages.

As shown in FIGS. 2 and 3, one variation of method S100 further includes Block S180, which recites receiving a return request, authorizing a return, and issuing a gift card balance to the user according to a value of the return. Generally, Block S180 functions to enable the user to return the good to the vendor despite payment for the good with an alternative payment method (that likely does not support returns or changes a fee for returns). In one example implementation, Block S180 issues a gift card to the recipient for the price of the transaction or for the price point of the payment method applied to the transaction. For example, Block S180 can issue a gift card as described in U.S. Patent Application No. 61/849,813. Alternatively, Block S180 can issue a coupon, credit, or special rate on a future transaction through the payment carrier or with the merchant. However, Block S180 can handle a return request in any other suitable way.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method, comprising:
receiving a transaction request comprising an identity of a user, a location of a vendor, and a price of a transaction;
identifying a set of payment methods available to the user, a particular payment method in the set of payment methods characterized by a discrete payment structure defining a discrete payment increment;
ranking the available payment methods according to a preferred payment method associated with the location of the vendor, according to the discrete payment structure of the particular payment method, and according to the price of the transaction;
receiving a selection from the user for the particular payment method for the transaction; and
authorizing a payment to the vendor with the particular payment method.

2. The method of claim 1, wherein receiving the transaction request comprises receiving a transaction request that comprises a cellular phone number associated with the user.

3. The method of claim 2, wherein receiving the selection for the particular payment method comprises receiving the selection though a mobile computing device that is assigned the cellular phone number.

4. The method of claim 1, wherein receiving the transaction request further comprises receiving an identifier of a class of good in the transaction, and wherein ranking the available payment methods further comprises ranking the available payment methods according to the class of good in the transaction, the identifier of the class of good specifying at least one of a virtual good, a tangible good, and an advertisement selection.

5. The method of claim 1, wherein identifying the set of payment methods available to the user comprises selecting the set of payment methods verified by the user and accepted by the vendor.

6. The method of claim 5, wherein identifying the set of payment methods available to the user comprises determining a preferred currency of the vendor based on the location of the vendor and selecting the set of payment methods that implement the preferred currency of the vendor.

7. The method of claim 1, wherein identifying the set of payment methods includes identifying a second payment method characterized by a continuous payment structure.

8. The method of claim 1, further comprising assessing a transaction risk for the particular payment method, wherein ranking the available payment methods further comprises ranking the available payment methods according to the transaction risk.

9. The method of claim 1, further comprising holding an overage for the payment according to the discrete payment increment of the particular payment method than exceeds the price of the transaction.

10. The method of claim 1, further comprising subsidizing a remainder of the payment according to the price of the transaction that exceeds the discrete payment increment of the particular payment method.

11. The method of claim 1, wherein ranking the available payment methods comprises ranking the available payment methods according to an outstanding subsidized payment amount, for a set of previous transactions, that is greater than a threshold subsidy amount.

12. The method of claim 1, wherein ranking the available payment methods further comprises ranking the available payment methods according to a user payment profile, the payment profile specifying selection of a payment method, by the user, for a prior transaction.

13. The method of claim 1, wherein identifying the set of payment methods available to the user comprises selecting the payment method as available for the transaction according to the discrete payment increment that is within a threshold range of the price of the transaction.

14. The method of claim 13, wherein receiving the selection for the particular payment method comprises storing the selection in the user payment profile.

15. The method of claim 1, wherein authorizing the payment to the vendor comprising identifying a carrier of the particular payment method, accessing a revenue share contract with the carrier, and authorizing the payment from the carrier to the vendor according to the revenue share contract.

16. The method of claim 15, wherein authorizing the payment to the vendor comprises accessing an exchange rate between currencies accepted by the vendor and implemented by the carrier and locking the exchange rate for the payment for a specified period of time.

17. The method of claim 1, wherein authorizing the payment to the vendor comprises authorizing multiple payments to the vendor according to the discrete payment increment of the particular payment method, a sum of the multiple payments to the vendor within a threshold range of the price of the transaction.

18. The method of claim 1, further comprising receiving a return request, authorizing a return, and issuing a gift card balance to the user according to a value of the return.

19. A method, comprising:
associating a set of payment methods with an account of a user, each payment method in the set of payment methods characterized by a discrete payment structure defining a discrete payment increment;
receiving a transaction request comprising an identity of a user, a location, and a price of a transaction;
ranking the set of payment methods according to a preferred payment method associated with the location and according to a payment increment, in the payment increments of the set of payment methods, that is within a threshold range of the price of the transaction;
receiving, from the user through a mobile computing device, a selection for a particular payment method, in the set of payment methods, for the transaction; and
authorizing a payment to the vendor with the particular payment method.

20. The method of claim 19, wherein receiving the selection for the particular payment method comprises receiving the selection through a touchscreen integrated into the mobile computing device, the touchscreen displaying a ranked list of the set of payment methods.
